(19) United States
(12) Patent Application Publication
(10) Pub. No.: US 2025/0238008 A1
(43) Pub. Date: Jul. 24, 2025

(54) Vehicle Transported sensitive data destruction system

(71) Applicant: Craftsmen Industries, Inc., St. Charles, MO (US)

(72) Inventors: Jacob Didion, Lake St. Louis, MO (US); Brian Orf, St. Louis, MO (US); Shane Drexler, Burien, WA (US)

(21) Appl. No.: 18/831,444

(22) Filed: Jan. 24, 2025

Related U.S. Application Data
(60) Provisional application No. 63/624,490, filed on Jan. 24, 2024.

(51) Int. Cl. G05B 15/02

(52) U.S. Cl. CPC G05B 15/02

(57) ABSTRACT

A vehicle transported sensitive data destruction system includes a grinding device positioned below a separator in an enclosure of the vehicle. Computer components to be destroyed are supplied to the separator and fall from the separator and into the grinding device where the components are ground into refuse particles. Refuse particles from the grinding device fall into a receptacle beneath the griding device. To accommodate the vertical arrangement of the separator, grinding device and receptacle in the vertical height of the vehicle enclosure, an opening is provided through the floor of the enclosure to accommodate the receptacle positioned below the grinding device.

### CROSS REFERENCE TO RELATED APPLICATION

This patent application claims the benefit of the filing date of the provisional patent application Ser. No. 63/624,490, which was filed on Jan. 24, 2024.

### BACKGROUND

The destruction of sensitive data recorded in a computer system, for example recorded on a hard drive, is typically done at a site remote from the computer system. This requires that any components of a computer system having recorded sensitive data desired to be destroyed must be securely transported from the location of the computer system to a remote site for destruction of the components. The computer system must be meticulously accounted for as the computer system is collected together for transport, then transported, and then unloaded for destruction. When it is desired to destroy sensitive data on a large number of computer systems, the task of collecting the large number of computer components with recorded sensitive data and providing secure transport of the components to a remote site for destruction of the components can be problematic.

### SUMMARY

The vehicle transported sensitive data destruction system of this disclosure overcomes problems often associated with the destruction of a large number of computer components having recorded sensitive data. This is accomplished by transporting the data destruction system to the location of the large number of computer components that need to be destroyed. The ability of the vehicle transported data destruction system to be located at the site of the computer components to be destroyed eliminates the need to collect the computer components with the recorded sensitive data and transport the components to a data destruction site.

The vehicle transported sensitive data destruction system includes a vehicle having an enclosure with a floor. The vehicle could be truck or a truck trailer, or other equivalent type of vehicle. There is an opening through the floor of the vehicle.

A grinding device is supported on the floor inside the enclosure. The grinding device is positioned over the opening through the floor. The grinding device could be a hammer mill or other equivalent type of grinding device.

A separator is supported on the floor inside the enclosure. The separator is positioned above the hammer mill. The separator could be a cyclone separator or other equivalent type of separator.

A supply bin is provided inside the enclosure. The supply bin is configured to store the computer components to be destroyed by the data destruction system. The supply bin is positioned on the floor inside the enclosure adjacent the separator and is connected in communication with the separator to supply the computer components to the separator.

A vacuum source is also provided inside the enclosure. The vacuum source is connected in communication with the separator and with the supply bin. The vacuum source is operable to create a vacuum pressure that draws computer components from the supply bin into the separator where the components will fall through the separator and into the hammer mill.

A conveyor is connected to the floor inside the enclosure. The conveyor extends downward from the floor and through the opening through the floor to a position beneath the hammer mill.

A receptacle is on the conveyor beneath the hammer mill. The receptacle is movable by the conveyor.

The conveyor is operable to move the receptacle from a position of the receptacle on the floor in the enclosure, downward through the opening through the floor to a position beneath the hammer mill, and to move the receptacle from the position beneath the hammer mill upward through the opening through the floor to the position of the receptacle on the floor in the enclosure.

### DESCRIPTION OF THE DRAWINGS

FIG. 1 is a representation of a side elevation view of the vehicle transported sensitive data destruction system of this disclosure.

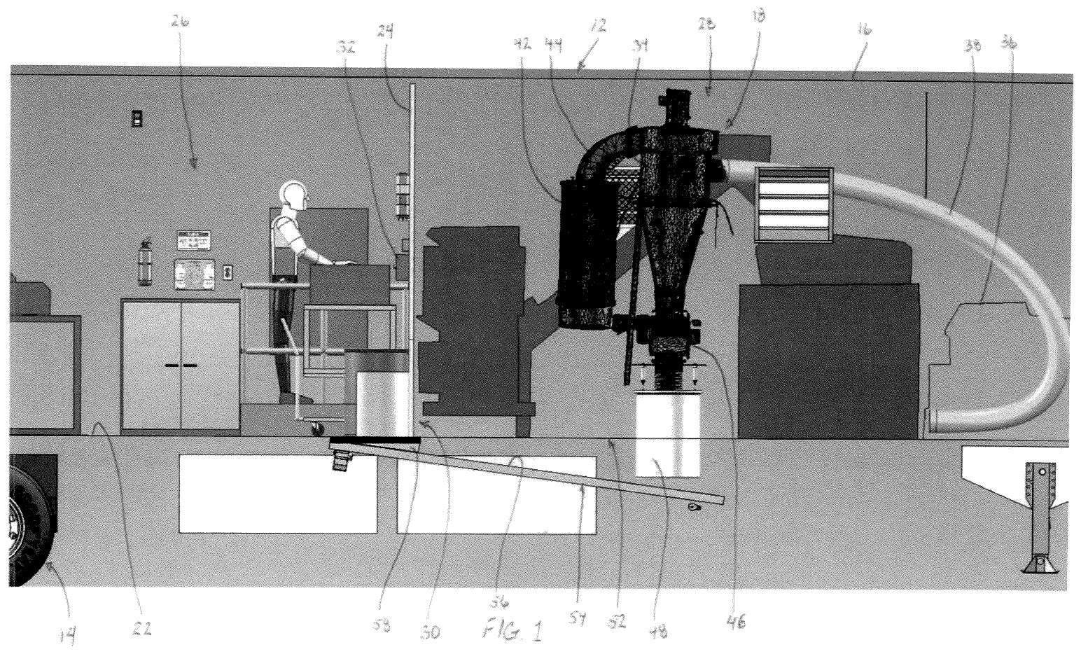

FIG. 2 is a representation of a perspective view of the system of FIG. 1.

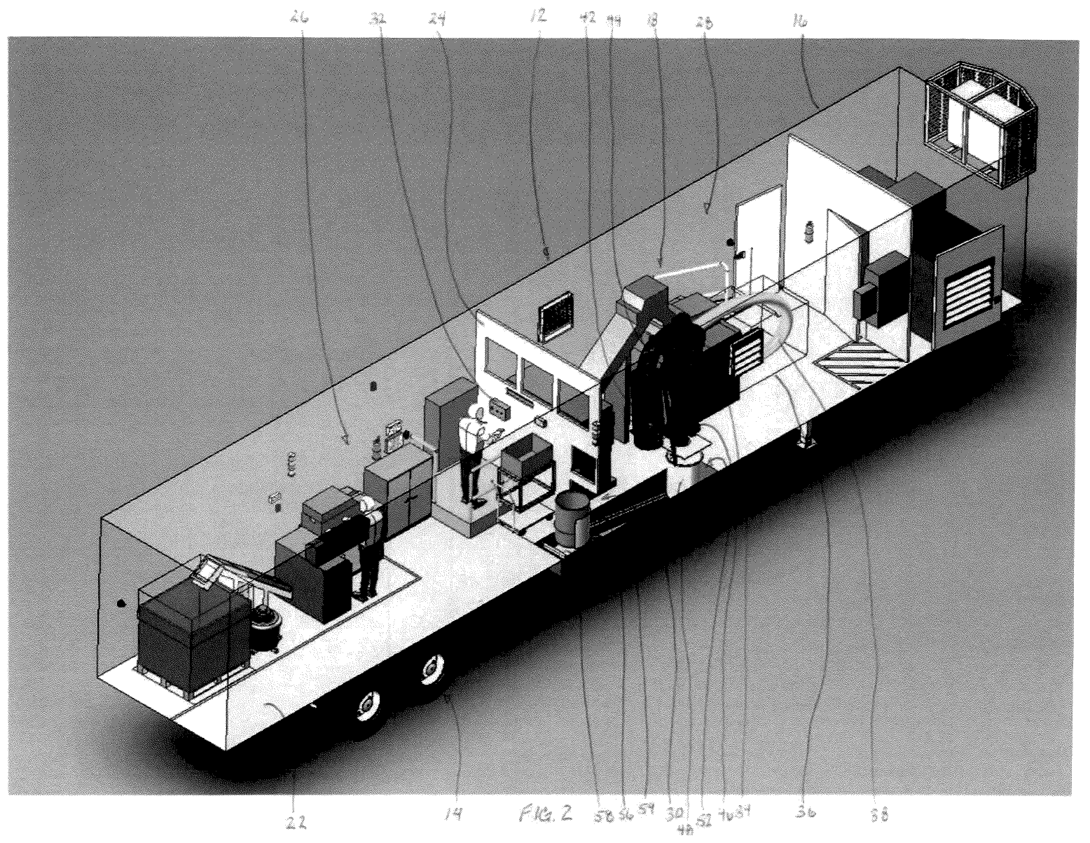

FIG. 3 is a representation of a perspective view of a conveyor of the system.

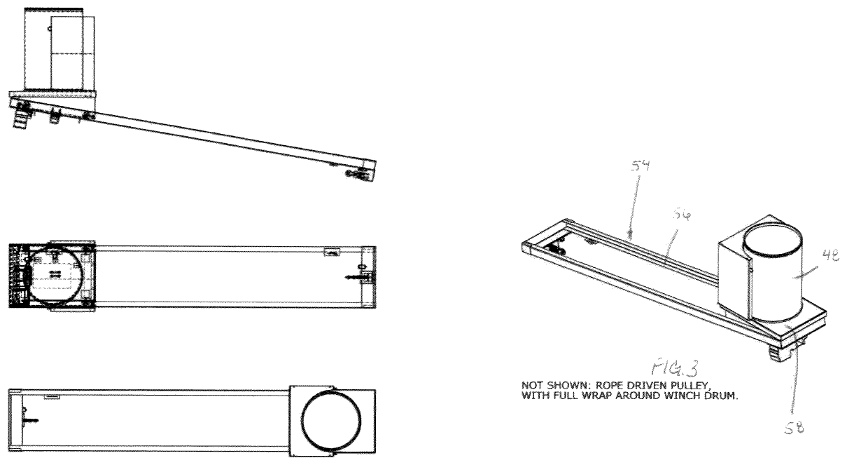

### DETAILED DESCRIPTION

The vehicle transported sensitive date destruction system 12 of this disclosure comprises a wheeled vehicle 14, for example a box truck or transport van, a truck trailer or other equivalent type of vehicle having an enclosure 16 containing a sensitive data destruction system 18 on the vehicle. The enclosure 16 on the vehicle 14 has a standard height dimension with a clearance that does not limit where the vehicle can be operated. The construction of the vehicle 14 enables the transport of the sensitive data destruction system 18 to a location of a large number of computer components having sensitive data recorded for destruction of the components at the location of the components.

The vehicle 14 includes a soundproof enclosure 16. The enclosure 16 is constructed of four exterior walls and a roof panel of sound proof or sound attenuating materials that protect the environment from noise generated in the enclosure 16. The enclosure 16 has a floor surface 22 and a soundproof interior wall 24 in the enclosure. The interior wall 24 separates an operation area 26 of the enclosure 16 from a destruction area 28 of the enclosure. The soundproof interior wall 24 protects inhabitants of the operation area 26 from the noise generated and any toxic fumes produced in the destruction area 28 of the enclosure 16. There is an opening 30 through the soundproof wall 24 adjacent the floor 22.

Manually operated computer controls 32 that operatively communicate with and control the destruction system 18 are located in the operation area 26 of the enclosure 16. The destruction system 18 is located in the destruction area 28 of the enclosure. The soundproof wall 24 separates occupants of the operation area 26 of the enclosure 16 from the noise generated by the destruction system 18 when destroying computer components with sensitive data in the destruction area 28 of the enclosure 16. The soundproof enclosure 16 is constructed to isolate the noise created by the destruction system 18 from the exterior environment of the vehicle 14.

The destruction system 18 includes a separator 34, for example a cyclone separator or other equivalent type of separator in the destruction area 28 of the enclosure 16. The cyclone separator 34 is oriented vertically and occupies much of the vertical height of the enclosure 16 surrounding the destruction area 28. Enclosing the separator 34 in the enclosure 16 prevents the noise created during operation of the separator from reaching the exterior environment of the vehicle 14.

The destruction system 18 also includes a supply bin 36 in the destruction area 28 of the enclosure 16. The supply bin 36 is configured to store computer equipment or components having recorded sensitive data that are desired to be destroyed. The supply bin 36 is operatively communicated with the cyclone separator 34 through a supply conduit or conveying system 38 or any equivalent type of communication connection 38.

A vacuum source 42 is also located in the destruction area 28 of the enclosure 16. The vacuum source 42 is operatively communicated with the cyclone separator 34 through a vacuum conduit 44 or other equivalent type of communication connection 44. The vacuum source 42 is operable to create a vacuum pressure in the cyclone separator 34 that draws stored computer components and/or parts of computer components from the supply bin 36 through the supply conduit 38 and into the cyclone separator 34. Enclosing the vacuum source 42 in the enclosure 16 prevents the noise created during operation of the vacuum source from reaching the exterior environment of the vehicle 14.

A griding device 46, for example a hammer mill 46 or other equivalent type of grinding device is located in the destruction area 28 of the enclosure 16. Enclosing the hammer mill 46 in the enclosure 16 prevents the noise created when operating the hammer mill from reaching the exterior environment of the vehicle 14. The hammer mill 46 communicates with a lower end of the cyclone separator 34 and also communicates with the supply bin 36 through the supply conduit or conveyor system 38. Computer components that are drawn by vacuum into the cyclone separator 34 are separated from other debris and fall through the cyclone separator and into the hammer mill 46 where the components are destroyed and pulverized. The hammer mill 46 is operable to pulverize computer components received into small refuse particles, for example refuse particles having a diameter dimension of less than 2 mm.

A refuse receptacle 48, for example a 55-gallon drum or other equivalent type of container is located below the hammer mill 46. The refuse receptacle 48 is positioned relative to the grinding device 46 to receive and hold the refuse falling from the hammer mill 46 that is produced from the computer components destroyed and pulverized by the hammer mill.

There is an opening 52 through the floor 22 of the vehicle 14 below the cyclone separator 34 and below the hammer mill 46. The vertical arrangement of the cyclone separator 34, the hammer mill 46 and the refuse receptacle 48 occupies more than the vertical space defined inside the enclosure 16. The opening 52 through the floor 22 is needed to accommodate the refuse receptacle 48 below the cyclone separator 34 and the hammer mill 46.

A conveyor 54 having a conveying surface 56 is operatively connected to the floor 22 of the vehicle 14. The conveyor 54 is positioned in the opening 52 through the floor. The conveyor 54 is movable upward and downward relative to the floor 22 between an upward, closed position where a conveying surface 56 of the conveyor occupies the opening 52 in the floor and closes the opening, and a downward, opened position where the conveying surface 56 is moved downward out of the opening through the floor 52. In the opened position the conveying surface 56 extends downwardly from the floor 22 in the operation area 26 of the enclosure 16, through the opening 52 through the floor 22 and through the opening 30 in the soundproof wall 24 to a position beneath the destruction area 28 of the enclosure 16 and beneath the cyclone separator 34, the hammer mill 46 and the refuse receptacle 48 below the hammer mill.

The conveyor includes a sled 58 supported on the conveying surface 56. The sled 58 is supported on the conveying surface 56 for movement of the sled upwardly and downwardly along the conveying surface. The sled 58 has a horizontally oriented surface configured to receive and support the refuse receptacle 48 on the sled and beneath the hammer mill 46. The conveyor 54 is operable to move the sled 58 and the refuse receptacle 48 up the conveying surface 56, through the opening 52 through the floor 22 of the enclosure 16 and through the opening 30 in the soundproof wall 24 from a position beneath the hammer mill 46 to a position in the operation area 26 of the enclosure 16.

The vehicle transported sensitive data destruction system 12 is operable by the vehicle 14 first being located at the location of the computer system(s) having sensitive data recorded on the components of the computer system(s). The components could be one component or a large number of components to be destroyed. The components are first loaded into the supply bin 36 of the vehicle 14 in preparation for their destruction.

The sensitive data destruction system 18 is then operated from the computer controls 32 in the operation area 26 of the enclosure 16. This involves operation of the vacuum source 42 to create a vacuum in the vacuum conduit 44 which communicates through the supply conduit 38 with the supply bin 36. The vacuum created in the supply conduit 38 draws and conveys computer components stored in the supply bin 36 through the supply conduit 38 and into the separator 34.

The separator 34 is operable to separate debris in the flow of air created by the vacuum from the vacuum source 32 from the computer components drawn into the separator 34. The separated computer components fall by gravity through the separator 34 and into the hammer mill of the grinding device 46.

The grinding device or hammer mill 46 is operable to pulverize and destroy the computer components falling from the separator 34 into the hammer mill 46. As stated earlier, the hammer mill 46 is operable to receive computer components into the hammer mill and grind and pulverize the components into small particles of refuse having a diameter dimension of less than 2 mm. The refuse created by the hammer mill 46 grinding the computer components falls from the hammer mill and into the receptacle 48. Operation of the hammer mill 46 is continued until the receptacle 48 is substantially filled.

The conveyor 54 is then operated to move the sled 58 and the filled receptacle 48 supported on the sled up the conveying surface 56. This moves the filled receptacle 48 from its position below the hammer mill 46 up the conveying surface 56, through the opening 52 through the floor and through the opening 30 through the soundproof wall 24 into the operation area 26 of the enclosure 16. In the operation area 26 the filled receptacle 48 can then be removed from the sled 58 and the enclosure 16 of the vehicle 14 and replaced with an empty receptacle. The conveyer 54 would then be operated to move the sled 58 supporting the empty receptacle from the operation area 26 downward along the conveying surface 56, through the opening 30 through the soundproof wall 24 and through the opening 52 through the floor 22 to position the empty receptacle beneath the hammer mill 46.

As various modifications could be made in the construction of the vehicle transported sensitive data destruction system and its method of operation herein described and illustrated without departing from the scope of the disclosure, it is intended that all matter contained in the foregoing description or shown in the accompanying drawings shall be interpreted as illustrative rather than limiting. Thus, the breadth and scope of the present disclosure should not be limited by any of the above described examples but should be defined only in accordance with the following claims appended hereto and their equivalents.

1. A vehicle transported sensitive data destruction system comprising:
an enclosure having a floor;
an opening through the floor;
a grinding device in the enclosure above the opening through the floor;
a conveyor connected to the floor, the conveyor extending from the floor downward through the opening through the floor to a position beneath the grinding device;
a receptacle on the conveyor; and
the conveyor being operable to move the receptacle through the opening through the floor from a position in the enclosure downward to a position beneath the grinding device, and to the move the receptacle from the position beneath the grinding device upward to the position in the enclosure.

2. The vehicle transported sensitive data destruction system of claim 1, further comprising:
a vehicle, the enclosure and the floor being on the vehicle and being transportable by the vehicle.

3. The vehicle transported sensitive data destruction system of claim 2, further comprising:
the vehicle being a truck trailer.

4. The vehicle transported sensitive data destruction system of claim 2, further comprising:
the grinding device being a hammer mill.

5. The vehicle transported sensitive data destruction system of claim 2, further comprising:
a separator in the enclosure above the hammer mill;
a supply bin in the enclosure, the supply bin being connected in communication with the separator;
a vacuum source in the enclosure, the vacuum source being connected in communication with the separator and the supply bin, the vacuum source being operable to create a vacuum that draws components from the supply bin into the separator where the components fall from the separator into the hammer mill.

6. The vehicle transported sensitive data destruction system of claim 5, further comprising:
the separator being a cyclone separator.

7. The vehicle transported sensitive data destruction system of claim 1, further comprising:
a control system operatively communicating with the grinding device, the control system being manually operable to control operation of the grinding device, and
a wall inside the enclosure and supported on the floor, the wall extending upward from the floor between the control system and the grinding device and separating the control system and the grinding device.

8. The vehicle transported sensitive data destruction system of claim 7, further comprising:
the wall being a soundproof wall.

9. The vehicle transported sensitive data destruction system of claim 1, further comprising:
the enclosure is constructed of soundproof and sound attenuating materials that protect an exterior environment of the enclosure from noise generated in the enclosure.

10. A vehicle transported sensitive data destruction system comprising:
a wheeled vehicle having an enclosure;
a grinding device inside the enclosure, the grinding device being operable to receive components to be destroyed and to grind the components into refuse particles;
a control system operatively communicating with the grinding device, the control system being manually operable to control operation of the grinding device; and
a container inside the enclosure, the container being positioned relative to the grinding device to receive refuse particles from the grinding device in the container; and
the container being configured for being moved from the grinding device and removed from the vehicle with the refuse particles in the container.

11. The vehicle transported sensitive data destruction system of claim 10, further comprising:
a supply bin inside the enclosure, the supply bin being configured for storing computer components having recorded sensitive data; and
a conveyor system operatively communicating the supply bin with the grinding device, the conveyor system being operable to convey computer components from the supply bin to the grinding device inside the enclosure.

12. The vehicle transported sensitive data destruction system of claim 11, further comprising:
a vacuum source inside the enclosure, the vacuum source communicating with the conveyor system and the supply bin, the vacuum source being configured to create a vacuum pressure that draws computer components from the supply bin to the grinding device.

13. The vehicle transported sensitive data destruction system of claim 12, further comprising:
an interior wall inside the enclosure, the interior wall being positioned inside the enclosure between the grinding device, the container, the supply bin, the conveyor system and the vacuum source on one side of the interior wall and the control system on an opposite side of the interior wall.

14. The vehicle transported sensitive data destruction system of claim 13, further comprising:
the interior wall being a soundproof wall.

15. The vehicle transported sensitive data destruction system of claim 13, further comprising:
the enclosure having a floor;
an opening through the floor, the opening being directly below the grinding device;
a conveyor connected to the floor, the conveyor extending from the floor downward through the opening through the floor to a position beneath the grinding device; and
the container being positioned on the conveyor.

16. The vehicle transported sensitive data destruction system of claim 15, further comprising:
the conveyor being configured for moving the container through the opening through the floor from a position in the enclosure downward to a position beneath the grinding device, and to move the container from the position beneath the grinding device upward through the opening to the position of the container in the enclosure.

17. A method of destroying sensitive data recorded in a computer system comprising:
locating a vehicle at a location of the computer system having sensitive data recorded on the components of the computer system;
conveying the components of the computer system to a grinding device on the vehicle;
operating the grinding device to grind the computer components conveyed to the grinding device into refuse particles;
collecting the refuse particles in a container on the vehicle; and
removing the container containing the refuse particles from the vehicle.

18. The method of claim 17, further comprising:
separating the grinding device from a control operatively communicating with the grinding device by an interior wall in the vehicle.

19. The method of claim 17, further comprising:
conveying the components of the computer system to the grinding device by a conveyor system communicating the grinding device with a supply bin on the vehicle containing the components of the computer system.

20. The method of claim 19, further comprising:
conveying the components of the computer system to the grinding device by a vacuum pressure created by a vacuum source on the vehicle.
